(19) United States
(12) Patent Application Publication
(10) Pub. No.: US 2004/0218926 A1
(43) Pub. Date: Nov. 4, 2004

(54) Optical add/drop multiplexer

(76) Inventors: Jong-Kwon Kim, Taejonkwangyok-shi (KR); Ki-Cheol Lee, Suwon-shi (KR); Jun-Ho Koh, Suwon-shi (KR); Yun-Je Oh, Yongin-shi (KR)

Correspondence Address: CHA & REITER, LLC, 210 ROUTE 4 EAST STE 103, PARAMUS, NJ, 07652, US

(21) Appl. No.: 10/686,860

(22) Filed: Oct. 16, 2003

(30) Foreign Application Priority Data
May 2, 2003 (KR) 2003-28231

(51) Int. Cl. H04J 14/02

(52) U.S. Cl. 398/83

(57) ABSTRACT

An optical add/drop multiplexer for adding or dropping a channel to an optical signal. The optical add/drop multiplexer includes a wavelength-division multiplexer to receive and transmit an optical signal, and a plurality of demultiplexing ports, each demultiplexing port is a path for a demultiplexed channel of the optical signal; and a plurality of add/drop multiplexers, wherein respective add/drop multiplexers are connected to respective demultiplexing ports, each of the add/drop multiplexers having a reflector for transmitting or reflecting an input channel, wherein each add/drop multiplexers is configured to add and/or drop a channel to/from from the wavelength-division multiplexer using the reflector.

### CLAIM OF PRIORITY

This application claims priority under 35 U.S.C. § 119 to an application entitled “Optical Add/Drop Multiplexer,” filed in the Korean Intellectual Property Office on May 2, 2003 and assigned Ser. No. 2003-28231, the contents of which are incorporated herein by reference.

### BACKGROUND OF THE INVENTION

1. Field of the Invention

The present invention relates generally to a wavelength division multiplexing (WDM) system, and in particular, to an optical add/drop multiplexer for adding or removing a predetermined channel to or from a multiplexed optical signal.

2. Description of the Related Art

Practical uses of WDM technology have been developed, where a plurality of channels with different wavelengths are transmitted using a single-core optical fiber. Accordingly, the transmission of an optical signal at a very high rate is facilitated. The development of optical device technology enables the ability to establish/switch an optical signal path, or to add/drop an optical signal. Thus, a WDM optical communication network can be configured.

In general, an optical add/drop multiplexer includes a pair of wavelength-division multiplexers (WDMs) and a plurality of optical switches. An arrayed-waveguide grating (AWG) is widely used as a WDM for a number of reasons, such as simple channel extension, easy control, and excellent integration capability. A 2×2 space switch or a wavelength-dependent fiber brag grating (FBG) is usually used as an optical switch.

FIG. 1 illustrates the structure of a conventional optical add/drop multiplexer. Referring to FIG. 1, the optical add/drop multiplexer includes first and second circulators (C1 and C2) 120 and 140, each circulator is connected to an optical fiber 110 for transmission of a multiplexed optical signal. In addition, the optical add/drop multiplexer has a plurality of ports, first to nth FBGs 131 to 133, and first and second WDMs (WDM1 and WDM2) 150 and 160. Here, n is a natural number equal to or greater than 3. For notational simplicity, if reference numeral “###” denotes a circulator 120 or 140, its m-th port will be provided with reference numeral “###m”, where m is a natural number. A multiplexed optical signal input/output to/from the optical add/drop multiplexer includes a plurality of channels at different wavelengths. It is assumed here that an m^{th} channel has wavelength m.

The first circulator 120 has first to third ports 1201 to 1203 for outputting an input optical signal to a lower port. The first circulator 120 outputs an optical signal received from the first port 1201 to the second port 1202. And, it outputs an optical signal received from the second port 1202 to the third port 1203.

The first to n^{th} FBGs 131 to 133 are connected between the second ports 1202 and 1402 of the first and second circulators 120 and 140. These FBGs pass an optical signal in an off state and reflect only a predetermined channel from the optical signal in an on state. For example, the second FBG 132 is set to reflect only a second channel λ2, and the nth FBG 133 is set to reflect only an n^{th} channel λn.

The first WDM 150 has a first multiplexing port (MP1) 151 and 11^{th} to 1n^{th} demultiplexing ports (DP11 to DP1n) 152 to 154. The first MP 151 is connected to the third port 1203 of the first circulator 120. The first WDM 150 outputs a channel received from the first MP 151 to a DP corresponding to the wavelength of the received channel. For example, the first WDM 150 outputs the second channel λ2 received through the first MP 151 to the 12^{th} DP 153, and the n^{th} channel λn to the 1nth DP 154.

The second circulator 140 outputs an optical signal received from the first port 1401 to the second port 1402, and an optical signal received from the second port 1402 to the third port 1403.

The second WDM 160 has a second MP 161 (MP2) and 21^{th} to 2n^{th} DPs (DP21 to DP2n) 162 to 164. The second MP 161 is connected to the first port 1401 of the second circulator 140. The second WDM 160 outputs channels received from the DPs 162 to 164 to the second MP 161.

The optical add/drop multiplexer drops the first channel λ1 from an input optical signal in a first case, and adds the second channel λ2 to the optical signal in a second case. These two cases will be described below.

A controller (not shown) sets the first and second FBGs 131 and 132 to the on state and the other FBG 133 to the off state. In the first case, the first circulator 120 outputs an optical signal received through the first port 1201 to the second port 1202, and the first FBG 131 reflects only the first channel λ1 from the optical signal. The first circulator 120 outputs the first channel λ1 received from the second port 1202 to the third port 1203. The first WDM 150 outputs the first channel λ1 received through the first MP 151 to the 11^{th} DP 152, thereby dropping the first channel λ1.

In the second case, an optical signal, having passed through the first to n^{th} FBGs 131 to 133, is input to the second port 1402 of the second circulator 140. The second circulator 140 outputs the optical signal to the third port 1403. The second WDM 160 outputs the second channel λ2 received through the 22^{th} DP 163 to the second MP 161. The second circulator 140 outputs the second channel λ1 received through the first port 1401 to the second port 1402. The second FBG 132 reflects the second channel λ2. The second circulator 140 outputs the second channel λ2 received through the second port 1402 to the third port 1403, thereby adding the second channel λ2 to the optical signal.

As described above, a conventional optical add/drop multiplexer has the plurality of FBGs 131 to 133 connected in serial. Therefore, the number of FBGs through which a channel is dropped or added must pass differs depending on the wavelength of the channel. For example, if the first channel λ1 is dropped, it is reflected from the first FBG 131. On the other hand, if the third channel λ3 is dropped, it must pass the first and second FBGs 131 and 132 twice. When a channel is added or dropped optical loss occurs during a pass through an FBG Therefore, its power differs according to its wavelength. Moreover, the FBGs 131 to 133 are usually controlled by ambient temperature and tension management, which takes a relatively long time. As a result, high-speed switching is difficult.

### SUMMARY OF THE INVENTION

Therefore, the present invention has been made to reduce or overcome the above mentioned problems involved with the related art. One object of the present invention is to provide an optical add/drop multiplexer which operates independently of the wavelength of an added or dropped channel and enables high-speed switching.

It is another object of the present invention to provide a low-price optical add/drop multiplexer with a simplified structure.

In accordance with the principles of the present invention, an optical add/drop multiplexer is provided, for adding or dropping a channel of an optical signal. The optical add/drop multiplexer includes a wavelength-division multiplexer to receive and transmit an optical signal, and a plurality of demultiplexing ports, each demultiplexing port is a path for a demultiplexed channel of the optical signal; and a plurality of add/drop multiplexers, wherein respective add/drop multiplexers are connected to respective demultiplexing ports, each of the add/drop multiplexers having a reflector for transmitting or reflecting an input channel, wherein each add/drop multiplexers is configured to add and/or drop a channel to/from from the wavelength-division multiplexer using the reflector.

### BRIEF DESCRIPTION OF THE DRAWINGS

The present invention will become more apparent from the following detailed description when taken in conjunction with the accompanying drawings in which:

FIG. 1 illustrates a conventional optical add/drop multiplexer;

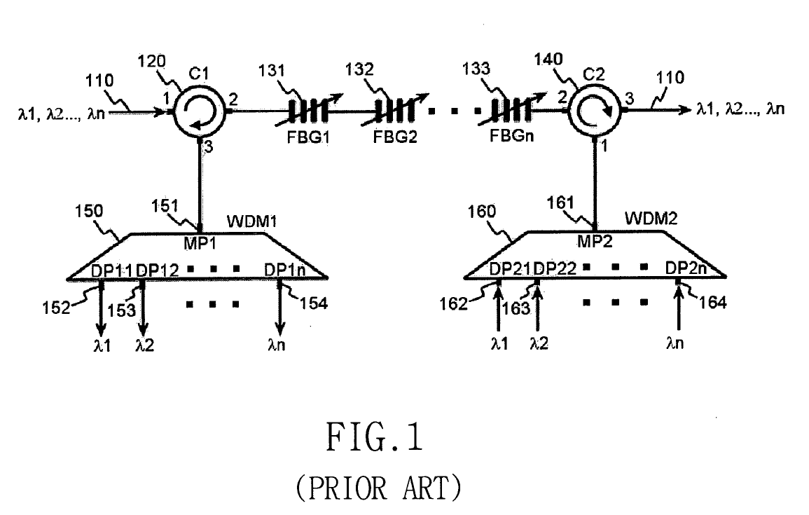

FIG. 2 is a block diagram of an optical add/drop multiplexer according to the present invention;

FIG. 3 illustrates an embodiment of the optical add/drop multiplexer according to the present invention; and

FIGS. 4A and 4B illustrate the operation of an n^{th} add/drop multiplexer (ADM) illustrated in FIG. 3.

### DETAILED DESCRIPTION OF THE PREFERRED EMBODIMENT

A preferred embodiment of the present invention will be described herein below with reference to the accompanying drawings. For the purposes of clarity and simplicity, well-known functions or constructions are not described in detail as they would obscure the invention in unnecessary detail.

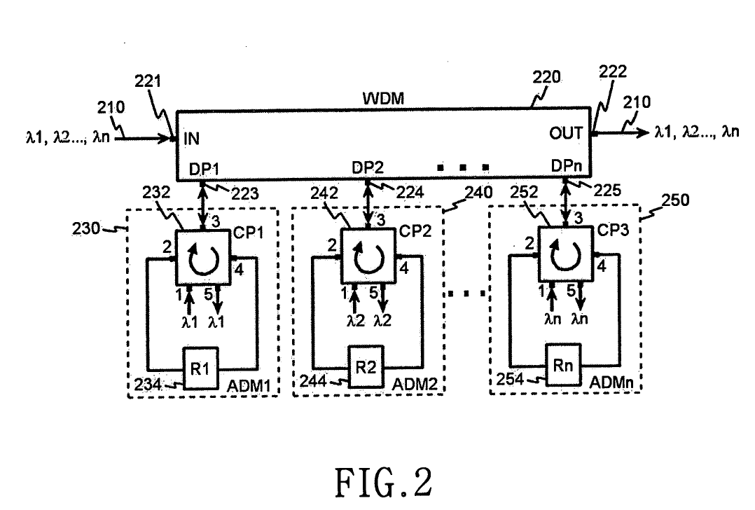

An optical add/drop multiplexer illustrated in FIGS. 2 to 4B includes circulating parts (CPs) or circulators, each CP or circulator having a plurality of ports. For notational simplicity, if reference numeral “###” denotes a CP or a circulator, its m-th port will be provided with reference numeral “###m”, where m is a natural number. A multiplexed optical signal input/output to/from the optical add/drop multiplexer includes a plurality of channels at different wavelengths. It is assumed here that an m^{th} channel has wavelength m.

FIG. 2 is a block diagram of the optical add/drop multiplexer according to the present invention. Referring to FIG. 2, the optical add/drop multiplexer is comprised of a WDM 220 and first to n^{th} ADMs (ADM1 to ADMn) 230 to 250 connected to the WDM 220. Here, n is a natural number equal to or greater than 3.

The WDM 220 includes an input port (IN) 221 and an output port (OUT) 222 which are connected to an optical fiber 210 for transmission of a multiplexed optical signal. First to nth DPs (DP1 to DPn) 223 to 225 serve as paths for demultiplexed channels. The WDM 220 wavelength-division demultiplexes a multiplexed optical signal received through the input port 221 and outputs each demultiplexed channel to a DP corresponding to the wavelength of the demultiplexed channel. For example, the WDM 220 outputs the second channel λ2 to the second DP 224 and the n^{th} channel λn to the n^{th} DP 225. Conversely, the WDM 220 wavelength-division multiplexes a plurality of wavelengths λ1 to λn received through the first to n^{th} DPs 223 to 225 and outputs the multiplexed optical signal through the output port 222.

The first to n^{th} ADMs 230 to 250 are connected to the first to n^{th} DPs 230 to 250 in a one to one correspondence. Each ADM includes a CP and a reflector (R). The first to n^{th} ADMs 230 to 250 are similar in configuration. Thus, the first ADM 230 will be described as a representative.

A first CP (CP1) 232 in the first ADM 230 has first to fifth ports 2321 to 2325 and outputs a channel received through a port to an adjacent lower port. For example, the first CP 232 outputs a channel received through the first port 2321 to the second port 2322, and the channel received through the second port 2322 to the third port 2323. The first port 2321 serves as a path for a channel that is added, and the fifth port 2325 serves as a path for a channel that is dropped. The third port 2323 is connected to the first DP 223. The second port 2322 is connected to the fourth port 2324.

A first reflector (R1) 234 in the first ADM 230 is connected to the second and fourth ports 2322 and 2324 of the first CP 232. It passes an input channel in an off state and reflects the channel in an on state. A bi-lateral reflector, which changes a transmittance and a transmitted wavelength according to a control signal and which is wavelength-independent, can be used as the first reflector 234.

The operation of dropping the first channel λ1 from an input optical signal and adding it to the optical signal in the optical add/drop multiplexer will be described.

A controller (not shown) sets the first reflector 234 to an on state and the other reflectors 244 to 254 to an off state in the first ADM 230. For dropping the first channel λ1, the WDM 220 wavelength-division demultiplexes an optical signal received through its input port 221 and outputs the demultiplexed first channel λ1 to the first DP 223 connected to the first ADM 230. The first CP 232 of the first ADM 230 outputs the first channel λ1 received through the third port 2323 to the fourth port 2324, and the first reflector 234 reflects the first channel λ1. The first CP 232 drops the first channel λ1 by outputting the first channel λ1 received through the fourth port 2324 to the fifth port 2325.

For adding the first channel λ1, the first ADM 230 outputs the first channel λ1 received through the first port 2321 to the second port 2322, and the first reflector 234 reflects the input first channel λ1. The first CP 232 outputs the first channel λ1 received through the second port 2322 to the third port 2323 connected to the first DP 223 of the WDM 220. The WDM 220 wavelength-division multiplexes the channels λ1 to λn received through the DPs 223 to 225 and outputs the multiplexed optical signal through the output port 222.

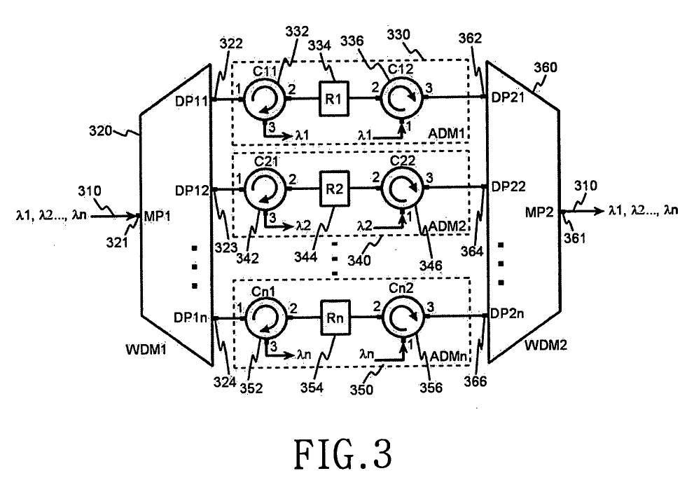

FIG. 3 illustrates an embodiment of the structure of the optical add/drop multiplexer according to the present invention. The optical add/drop multiplexer includes first and second WDMs (WDM1 and WDM2) 320 and 360, and first to n^{th} ADMs (ADM1 to ADMn) 330 to 350 connected between the first and second WDMs 320 and 360.

The first WDM 320 is comprised of a first MP (MP1) 321 connected to an optical fiber 310 for transmission of a multiplexed optical signal and 11^{th} to 1n^{th} DPs (DP11 to DP1n) 322 to 324. The first WDM 320 wavelength-division demultiplexes a multiplexed optical signal received through the first MP 321 and outputs each demultiplexed channel to a DP corresponding to the wavelength of the demultiplexed channel. For example, the first WDM 320 outputs the second channel λ2 to the 12^{th} DP 323 and the n^{th} channel λn to the 1n^{th} DP 324. AWGs can be used as the first and second WDMs 320 and 360 (because of simple channel extension, easy control, and excellent integration capability).

The first to n^{th} ADMs 330 to 350 are connected to the 11^{th} to 1n^{th} DPs 322 to 324 in a one to one correspondence. Each ADM includes a pair of circulators and a reflector. The first to n^{th} ADMs 330 to 350 are similar in configuration. Thus, the first ADM 330 will be described as a representative.

An 11^{th} circulator (C11) 332 in the first ADM 330 has first to third ports 3321 to 3323 and outputs a channel received through a port to its adjacent lower port. The first port 3321 of the 11^{th} circulator 332 is connected to the 11^{th} DP 322 of the first WDM 320. The 11^{th} circulator 332 outputs the first channel λ1 received through the first port 3321 to the second port 3322, and the first channel λ1 received through the second port 3322 to the third port 3323, thereby dropping the first channel λ1.

A first reflector 334 (R1) of the first ADM 330 is connected to the second port 3322 of the 11^{th} circulator 332 and the second port 3362 of a 12^{th} circulator (C12) 336. It passes an input channel in an off state and reflects the channel in an on state. A bi-lateral reflector, which changes a transmittance according to a control signal and is wavelength-independent, can be used as the first reflector 334.

The 12^{th} circulator 336 in the first ADM 330 has first to third ports 3361 to 3363 and outputs a channel received through a port to its adjacent lower port. The 12^{th} circulator 336 outputs the first channel λ1 received through the first port 3361 to the second port 3362, and the first channel λ1 received through the second port 3362 to the third port 3363, thereby adding the first channel λ1.

The second WDM 360 is comprised of a second MP (MP2) 361 connected to the optical fiber 310 and 21^{th} to 2n^{th} DPs (DP21 to DP2n) 362 to 366. The second WDM 360 wavelength-division multiplexes a plurality of channels received through the 21^{th} to 2n^{th} DPs 362 to 366 and outputs the multiplexed optical signal to the second MP 361.

The operation of dropping the first channel λ1 from an input optical signal and adding the second channel λ1 to the optical signal in the thus-constituted optical add/drop multiplexer will be described.

A controller (not shown) sets the first reflector 334 to an on state and the other reflectors 344 to 354 to an off state in the first ADM 330. For dropping the first channel λ1, the first WDM 320 wavelength-division demultiplexes an input optical signal and outputs the demultiplexed first channel λ1 to the 11^{th} DP 322 connected to the 11^{th} circulator 332 of the first ADM 330. The 11^{th} circulator 332 outputs the first channel λ1 received through the first port 3321 to the second port 3322, and the first reflector 334 reflects the first channel λ1. The 11^{th} circulator 332 drops the first channel λ1 by outputting the first channel λ1 received through the second port 3322 to the third port 3323.

For adding the first channel λ1 in the first ADM 330, the 12^{th} circulator 336 outputs the first channel λ1 received through the first port 3361 to the second port 3362, and the first reflector 334 reflects the input first channel λ1. The 12^{th} circulator 336 outputs the first channel λ1 received through the second port 3362 to the third port 3363 connected to the 21^{th} DP 362 of the second WDM 360. The second WDM 360 wavelength-division multiplexes the channels λ1 to λn received through the 21^{th} to 2n^{th} DPs 362 to 366 and outputs the multiplexed optical signal through the second MP 361.

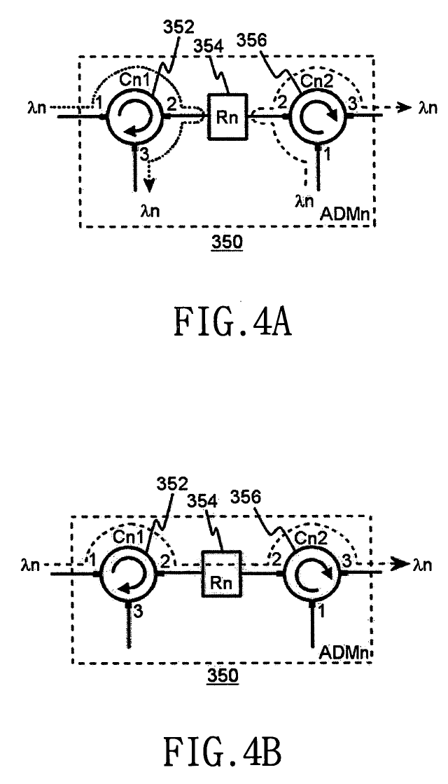

FIGS. 4A and 4B illustrate the operation of the n^{th} ADM illustrated in FIG. 3.

FIG. 4A illustrates adding a dropped n^{th} channel λn in the n^{th} ADM 350. For dropping the n^{th} channel λn, an n1^{th} circulator (Cn1) 352 outputs the n^{th} channel λn received through a first port 3521 to a second port 3522. An n^{th} reflector (Rn) 354 is set to an on state and reflects the input n^{th} channel λn. The n1^{th} circulator 352 drops the n^{th} channel λn by outputting the n^{th} channel λn received through the second port 3522 to the third port 3523. For adding the n^{th} channel λn, an n2^{th} circulator (Cn2) 356 outputs the n^{th} channel λn received through a first port 3561 to a second port 3562. The n^{th} reflector 354 reflects the n^{th} channel λn. The n2^{th} circulator 362 adds the n^{th} channel λn by outputting the n^{th} channel λn received through the second port 3562 to the third port 3563.

FIG. 4B illustrates transmitting the n^{th} channel λn in the n^{th} ADM 350. Referring to FIG. 4B, the n1^{th} circulator 352 outputs the n^{th} channel λn received through the first port 3521 to the second port 3522. The n^{th} reflector 354 is set to an off state and transmits the input n^{th} channel λn. The n2^{th} circulator 356 outputs the n^{th} channel λn received through the second port 3562 to the third port 3563.

Advantageously, the optical add/drop multiplexer of the present invention adds and/or drops a channel independently of the wavelength, by using circulators as passive devices and wavelength-independent reflectors. In this manner, high-speed switching is possible and can be easily controlled.

The use of the circulators and the wavelength-independent reflectors also minimizes the number of auxiliary devices, such as temperature controllers. As a result, the optical add/drop multiplexer has a simplified structure and a lower cost of fabrication is achieved.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An optical add/drop multiplexer for adding or dropping a channel to an optical signal, comprising:
a wavelength-division multiplexer to receive and transmit an optical signal, and a plurality of demultiplexing ports, each demultiplexing port is a path for a demultiplexed channel of the optical signal; and
a plurality of add/drop multiplexers, wherein respective add/drop multiplexers are connected to respective demultiplexing ports, each of the add/drop multiplexers having a reflector for transmitting or reflecting an input channel, wherein each add/drop multiplexers is configured to add and/or drop a channel to/from from the wavelength-division multiplexer using the reflector.

2. The optical add/drop multiplexer of claim 1, wherein the wavelength-division multiplexer is connected to an optical fiber to receive an multiplexed optical signal, and has input and output ports as a path for the multiplexed optical signal.

3. The optical add/drop multiplexer of claim 2, wherein each of the plurality of add/drop multiplexers has a plurality of ports for outputting an input channel to an adjacent lower port.

4. The optical add/drop multiplexer of claim 3, wherein the optical add/drop multiplexer is connected to an optical fiber on which the multiplexed optical signal is transmitted.

5. The optical add/drop multiplexer of claim 4, wherein each of the add/drop multiplexers drops a channel by outputting the channel received through a third port connected to the wavelength-division multiplexer to a fourth port and outputting the channel received through the fourth channel to a fifth channel by the reflector, and adds a channel by outputting the channel received through a first port to a second port and outputting the channel received through the second port to a third port by the reflector.

6. The optical add/drop multiplexer of claim 1, wherein each of the reflectors are wavelength-independent reflectors

7. An optical add/drop multiplexer for adding and/or dropping a channel to an optical signal, comprising:
a first wavelength-division multiplexer for wavelength-division demultiplexing a received optical signal and providing respective demultiplexed channels to respective demultiplexing ports, each demultiplexing port corresponding to the wavelength of the demultiplexed channel;
a plurality of add/drop multiplexers, wherein respective add/drop multiplexers are connected to respective demultiplexing ports, each add/drop multiplexer having first and second circulators and a reflector connected between the first and second circulators, for transmitting or reflecting an input channel;
a second wavelength-division multiplexer for wavelength-division multiplexing a plurality of received channels, the second wavelength-division multiplexer having a plurality of demultiplexing ports, wherein respective demultiplexing ports are connected to respective add/drop multiplexers,
wherein each add/drop multiplexer is configured to add and/or drop a channel to/from from the wavelength-division multiplexer using the first and second circulators and reflector.

8. The optical add/drop multiplexer of claim 7, wherein the first wavelength-division multiplexer connected to an optical fiber to receive a multiplexed optical signal.

9. The optical add/drop multiplexer of claim 7, wherein each of the plurality of add/drop multiplexers has a plurality of ports for outputting an input channel to an adjacent lower port.

10. The optical add/drop multiplexer of claim 7, wherein the first circulator drops a channel by outputting the channel received through a first port connected to the first wavelength-division multiplexer to a fourth port and outputting the channel received through the second channel to a third channel by the reflector.

11. The optical add/drop multiplexer of claim 7, wherein and the second circulator adds a channel by outputting the channel received through a first port to a second port and outputting the channel received through the second port to a third port connected to the second wavelength-division multiplexer by the reflector.

12. The optical add/drop multiplexer of claim 7, wherein each of the reflectors are wavelength-independent reflectors

13. The optical add/drop multiplexer of claim 7, wherein each of the first and second wavelength-division multiplexers includes an arrayed-waveguide grating.
